(19) United States
(12) Patent Application Publication
(10) Pub. No.: US 2001/0029679 A1
(43) Pub. Date: Oct. 18, 2001

(54) Curve creator and duplicator

(76) Inventor: Joseph Carl Peters, Downingtown, PA (US)

Correspondence Address: Joseph C. Peters, 127 Longfields Way, Downingtown, PA, 19335, US

(21) Appl. No.: 09/734,159

(22) Filed: Dec. 11, 2000

Related U.S. Application Data
(60) Provisional application No. 60/170,443, filed on Dec. 11, 1999.

(51) Int. Cl. G01B 5/20

(52) U.S. Cl. 33/561.3; 33/561.1

(57) ABSTRACT

The present invention relates to a drawing apparatus specifically one that allows the user to generate smooth arced and curved lines. The present invention has the advantage to allow the user to create unique arcs and curved lines, rather than follow predetermined templates. The present invention also increases the quality of work because the present invention allows for a unique curve to be created, while French curve templates often require several predetermined templates and curves to be used in combination to create a desired curve. The present invention allows for a unique curve to be saved by tightening the guide track into a locked position. Furthermore the present invention allows for a unique curve to be metered and replicated again at a later time.

### CROSS-REFERENCE TO RELATED APPLICATIONS

This application claims the benefit of Provisional Patent Application Ser. No. 60/170443, filed Dec. 11, 1999.

### BACKGROUND OF THE INVENTION

This invention relates to a drawing apparatus, specifically one that allows the user to generate smooth arced and curved lines. Draftsmen and designers are frequently required to generate smooth and unique curves for their work.

In the design industry, there is often the need to produce and include curved lines within drawing projects. Currently most designers and draftsmen use a French curve. The French curve is non-adjustable template, and accordingly a designer or draftsperson often chooses a French curve that is most similar to the curve they wish to create or trace. French curve templates limit and influence and designers creativity and skill to the amount of French Curve templates he or her may have available to them. To counterbalance the limits of the French curve, designers and draftsmen are required to have a large set of French curves. A large set of French curves is not only expensive, but also has the disadvantages of storage and transportation, plus the need to search through the set for a matching curve. The present invention works parallel with the creative process of a designer to allow them to create a unique curve for their drawing application. Quality of drawing work is increased because the present invention allows for a unique curve to be created, while French curve templates often require several predetermined templates and curves to be used in combination to create a desired curve. The use of several templates together often shows a visible overlap of curved lines especially, when a desired curve is created with a dark medium such as a felt tip marker. The present invention allows for a unique curve to be saved by tightening the guide track into a locked position. This feature of saving the unique curve is useful if the curve later needs to be thickened or darkened with new medium. This feature also allows for a series of unique curves to be created equal distance to each other. To achive two or more curves that are equal distance to each other, the apparatus must simple be moved perpendicular to the flexible edge guide. To accomplish the same task of creating unique equal distance curves with templates is very difficult and not accurate. Furthermore the present invention allows for a unique curve to be measured and replicated again at a later time.

Several objects and advantages of the present invention are:

(a) To allow the user to create a unique curve rather that, choosing a similar, inaccurate, and predetermined curve from a template.

(b) To increase quality of drawing work because the present invention allows for a unique curve to be created, while French curve templates often require several predetermined templates and curves to be used in combination to create a desired curve. The use of several templates together often shows a visible overlap of curved lines especially, when a desired curve is created with a dark medium such as a felt tip marker.

(c) To allow for a unique curve to be saved by tightening guide track into a locked position.

(d) To allow for a series of unique curves to be created equal distance to each other.

(e) To allow for a unique curve to be measured and replicated again at a later time. Further objects and advantages of my invention will become apparent from a consideration of the drawings and ensuing description.

### BRIEF SUMMARY OF THE INVENTION

The purpose of this invention is to allow someone to generate smooth curves and arcs. Draftsmen and designers need to be able to generate smooth curves for projects. The present invention has the ability to create a wide range of different curves and arcs. It also allows for the curve that has been created to be recreated exactly the same at a later time or by someone else with the same instrument. This can be very useful for an automobile designer who often requires a smooth arc and may need to recreate the exact same arc later on different drafts of his or her project. Arcs are tough to trace since they can not be put against a straight edge. If a designer is tracing a drawing through a layer of vellum, the curve creator can be used to create a curved edge guide to trace along with any medium such and a drafting pen. Unlike a French curve template the present invention is able to generate a multitude of unique curve types.

### BRIEF DESCRIPTION OF THE SEVERAL VIEWS OF THE DRAWING

FIG. 1 is a perspective view of one preferred embodiment of the present invention.

FIG. 2 is a plan view of the apparatus shown in FIG. 1.

### DESCRIPTION OF THE DRAWINGINGS

Reference Numerals In Drawings

1-frame

2a-1^{st} adjustment member

2b-2^{nd} adjustment member

2c-3^{rd} adjustment member

3-flexible edge guide

4a, 4b- solid ball members that attach to 3^{rd} adjustment member

5a, 5b- solid ball members that attach to 2^{rd} adjustment member

6a, 6b- solid ball members that attach to 1^{rd} adjustment member

7a, 7b- guide channels

8a, 8b- locking members which are used to sandwich flexible edge guide

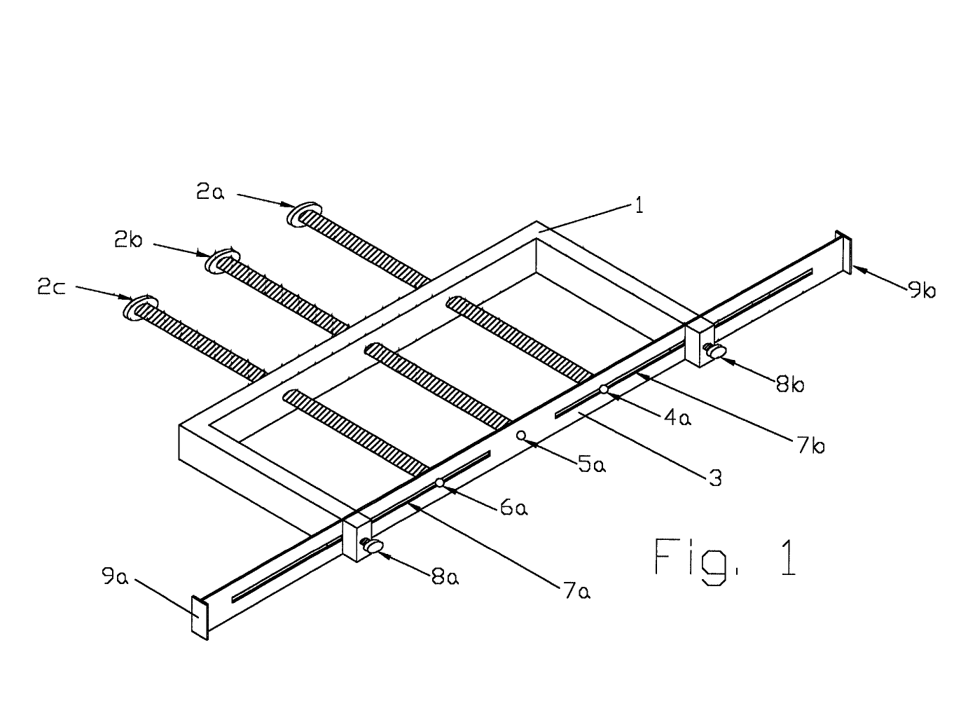

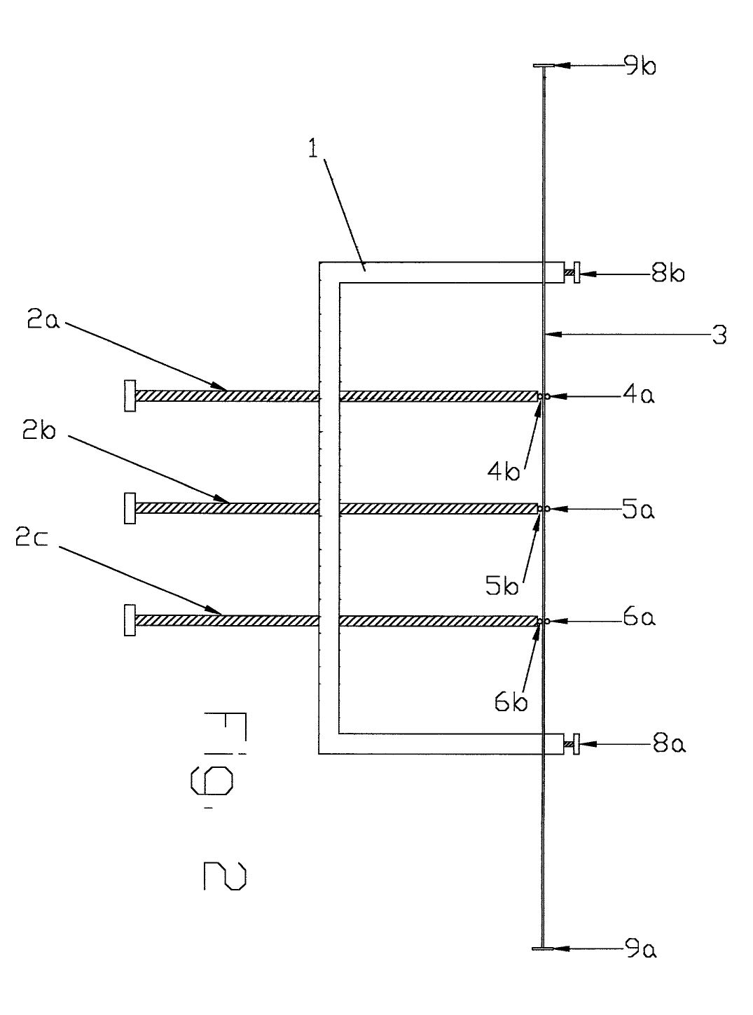

The preferred embodiment of the present invention is illustrated in FIG. 1 (perspective view) and FIG. 2 (plan view). In FIG. 1 a frame member 1 is shown with three adjustment members 2a, 2b, 2c connected to it. Said adjustment members 2a, 2b, 2c are represented as threaded rod in the preferred embodiment. In FIG. 2, adjustment member 2a is connected to solid ball member 4b. FIG. 2 also shows solid ball member 4b is connected to solid ball member 4a. FIG. 2 also shows solid ball members 4a, 4b are sandwiching the flexible edge guide 3. In FIG. 2 the said flexible edge guide is able to move generously against solid ball members 4a, 4b because of the guide channel 7b of the said flexible edge guide shown in FIG. 1. In FIG.2 adjustment member 2c is connected to solid ball member 6b. In FIG. 2 solid ball member 6b is connected to solid ball member 6a. Also in FIG. 2 solid ball members 6a, 6b are sandwiching the flexible edge guide 3 shown in FIG. 1. The said flexible edge guide is also able to move generously against solid ball members 6a, 6b because of the said guide channel 7a of the said flexible edge guide 3. In FIG. 1 adjustment member 2b is connected to solid ball member 5b. In FIG. 2 solid ball member 5b is connected to solid ball member 5a. In FIG. 2 also solid ball members 5a, 5b are sandwiching the flexible edge guide 3. FIG. 1 shows how the frame member 1 also sandwiches the flexible edge guide 3. The flexible edge guide 3 is attached to two ends of the frame 1 by locking members 8a, 8b. Locking members 8a, 8b are represented as threaded rod in the preferred embodiment. Locking member 8a sandwiches the flexible edge guide 3 between itself and the frame 1. Locking member 8a also goes through guide channel 7a. Likewise locking member 8b sandwiches the flexible edge guide 3 between itself and locking and the frame 1. Locking member 8b also goes though guide channel 7b.

In the preferred embodiment the three sided frame member 1 would be fabricated from a rigid material such as steel or aluminum. The three adjustment members 2a, 2b, 2c and locking members 8a, 8b would also ideally be fabricated from a rigid material such as steel or aluminum. In this embodiment the adjustment members 2a, 2b, 2c and the locking members 8a, 8b are represented as threaded rod and therefore the frame member 1 must me tapped at the same scale of the threaded rod in order to except the members and their designated locations. The flexible edge guide 3, must be thin and flexible. A resilient material such as spring steel or a thin acrylic plastic are ideal materials for the flexible edge guide 3. The solid ball members 4a, 4b, 5a, 5b, 6a, 6b, all would ideally be fabricated from a rigid material such as steel or aluminum.

The adjustable curve drawing apparatus illustrated in the preferred embodiment of FIG. 1 and FIG. 2, operates in the following simple manner. Namely, one twists any of the adjustment members 2a, 2b, 2c in relation to the frame member 1. Since in the preferred embodiment the adjustment members 2a, 2b, 2c are threaded rod, they will move respectively against the tapped frame member 1 either positively or negatively. This positive or negative movement of any or all the adjustment members 2a, 2b, 2c along the frame 1 will accordingly cause the flexible edge guide 3 to take on a shape approximating a curve. The applicant has found that by controlling the relative positions of the adjustment members 2a, 2b, 2c that the flexible edge guide 3 can generate multitude or unique curves. Once a desired curve shape is achieved with the flexible edge guide 3, its path can be transferred to a drawing surface by a drawing medium of choice. Locking members 8a, 8b may be used to keep the flexible edge guide 3 in a fixed position. Any curved shape that has been created by the apparatus can be measured and replicated exactly the same at a later time or by someone else with the same instrument. This is done by simply recording 3 measurements, which are the distances that the adjustment members 2a, 2b, 2c protrude from the frame member 1.

The principles of the invention have been made clear in the illustrative embodiments. It may also be obvious to those skilled in the art many modifications of structure, arrangement, proportions, the elements, materials, and components used in the practice adapted for specific environments and operative requirements without departing from those principles. The appended claims are intended to cover and embrace all such modifications, within the limits only of the true spirit and scope of the invention. This specification and the appended claims have been prepared in accordance with the applicable patent laws and the rules promulgated under the authority thereof

What is claimed is:

1. Adjustable curve drawing apparatus, comprising in combination:
a. a. frame
b. said frame has one or more adjustable members passing through it to said elongated flexible edge guide;
c. elongated flexible said edge guide;
d. attachment means for attaching frame to a said elongated flexible edge guide by a given amount of one or more adjustment members,
e. flexible, elongated guide track attached to said adjustment members between two pinned solid ball members.
f Adjustment members connecting elongated flexible guide track, whereby movement of said elongated flexible guide track is controlled by adjustment members with sliding movement to cause said elongated flexible guide track to assume a different curved shape;
g. lockable means of flexible edge guide, once desired curved shape is achieved
